(19) United States
(12) Patent Application Publication
(10) Pub. No.: US 2022/0136881 A1
(43) Pub. Date: May 5, 2022

(54) SMART DEVICE FOR FUEL CYLINDER

(71) Applicants: Liji Huang, Santa Clara, CA (US); Chih-Chang Chen, Cupertino, CA (US)

(72) Inventors: Liji Huang, Santa Clara, CA (US); Chih-Chang Chen, Cupertino, CA (US)

(73) Assignee: Siargo Ltd., Santa Clara, CA (US)

(21) Appl. No.: 17/088,910

(22) Filed: Nov. 4, 2020

(51) Int. Cl. G01F 1/684; G01F 1/688; F17C 13/04

(52) U.S. Cl. CPC G01F 1/6845; G01F 1/688; F17C 13/04; F17C 2250/0443; F17C 2250/043; F17C 2250/0439; F17C 2205/0338

(57) ABSTRACT

The design and structure of an integrated MEMS mass flow meter with a conventional pressure regulator for fuel gas cylinder enabled with wireless data communication is exhibited in this disclosure. The battery-powered MEMS mass flow meter integrated with a pressure sensor, a temperature sensor and a Bluetooth as well as one long-distance communication devices is packed by the conventional fuel gas cylinder mechanical pressure regulator to form a new integrated apparatus. Such an apparatus can digitize the fuel gas consumption supplied by a cylinder to provide such consumption information to the fuel gas cylinder suppliers or the third-party service providers, and will also timely stream the cylinder status such as leakage and location data which will significantly improve the efficiency of fuel gas usage, control, and its supply logistics.

### BACKGROUND OF THE INVENTION

### 1. Field of the Invention

This invention generally relates to fluid flow measurement, and it particularly relates to a flow measurement apparatus that utilizes micro-electro-mechanical system (MEMS) mass flow sensing technology to measure the gas dispensing and consumption for fuel tanks or cylinders. This invention is further related to the internet of things (IOT) that connect multiple devices and relay such information to cloud computing in the eases of data management and cost reduction.

### 2. Description of the Related Art

While the promotion of city energy by clean fuels via the pipeline has been a task committed by many governments in the world, there are still many places that the energy supply is realized by the fuel gas cylinders. On the one hand, clean energy such as natural gas may not be readily available everywhere, on the other, pipeline construction is very costly particularly in some remote areas where there is only a limited population. Consequently, there are millions of fuel cylinders being delivered daily worldwide. Up to date, each of those fuel cylinders only has a mechanical pressure regulator to ensure the safety of the fuel gas consumption. There are no available devices for metering the actual gas consumption, monitoring the gas leakage safety, not to mention any logistical management at the fuel cylinder level. The refilling of the cylinder will be often the responsibility of the customer with the only option for the judgments of consumption by speculation. Customers may have the chance to be cut off from the supply due to the underestimate of the usage. Today, some companies have taught their customer to estimate the cylinder gas volumes by applying hot water on the surface of the cylinder and subsequently touch the surface as the level of the gas would lead to a different cylinder surface temperature. Sometimes the customer may shake the cylinder and hear the sound to judge the level of the gas remaining in the cylinder. Either of the above approaches is not only impractical but also will have safety issues. Bouvier (D. Bouvier, gas bottle with an alarm device, EP1843078A1, Oct. 10, 2007) discloses a float that is coupled to a valve and can be placed inside the gas cylinder such that the float can level the usage of the liquid petroleum gas. Such a device is a purely mechanical one and had usually a larger error towards a lower level of usage. It is not convenient as the user will need frequent attention to the indicator, and the low accuracy will also cost the tariff imbalance. Besides, it will not be able to detect any gaseous phase that will become more and more important after the cylinder is half-empty. Alternatively, Humphery (R. L. Humphery, Apparatus for monitoring fluid levels in a remotely located storage tanks, U.S. Pat. No. 7,937,215, May 3, 2011) discloses a mechanical shaft with a dialing gauge coupled with a magnet to sending the signal of a float level inside the liquid gas cylinder. Although this disclosure solved the issue of signal transmission but again had the same issue of a mechanical float which further requires that the cylinder must be perfectly leveled otherwise depending on the level and the float position, the actual gas consumption can be seriously misled. Both of the two disclosures will also require a special cylinder that shall include a float inside which is not only costly but the glass tube level indicators would also be prone to get damaged for a high volume application. Another alternative approach with a specially made cylinder that has an acoustic level sensor inside (Olah, L., Acoustic liquid level detection, US Patent Applications, 2012/0031182, Feb. 9, 2012) would have similar issues for the accuracy, cost, and external devices. Suman (S. Suman, Propane tank continuous monitoring system, U.S. Pat. No. 9,851,053, Dec. 26, 2017) teaches a system using a load sensor to be used to monitor the consumption of propane gas from a cylinder. While the load sensor is serving as the scale and requires close contact between the cylinder and the sensor enclosure, the actual consumption of the gas will only be calculated based on the weight loss of the cylinder. However, this will not only require a clear knowledge of the empty cylinder weight as well as that of a full tank. As a vast member of cylinders with different manufacturers, this knowledge would not be readily available and accurate. Also, any deviations of the gas density and improper engagement of the cylinder with the load sensor would introduce unspecified errors. In addition, the load sensor is often having a small dynamic range without being able to gauge the liquid-gas phase inside a cylinder.

In a most recent disclosure (Wise, E. C., Method and apparatus for monitoring, communicating and analyzing the amount of fluid in a tank, U.S. Pat. No. 9,435,675, Sep. 6, 2016), a special device is proposed to monitor the remaining mass of a gas container. Inside the special device, a flow meter is used to measure a plurality of flow rates that vary when being dispensed, and the embedded processor shall be used to determine the remaining mass and an indication shall then be generated by the device. However, the disclosed device for the gas consumption is based on the rolling mean or average of a plurality of non-continuous measured flow rate that may be quite deviated from the actual mass as it also requires the knowledge of the gas density, pressure, and temperature. The disclosed device can be remotely connected to a system comprised of a robot and a software application for remote gas data management. While this does provide values to the management of the logistics of the gas bottles or cylinders, the actual user(s) of the gas containers are left out of the cycle as the user(s) must only be at the promise close to the gas containers to know the status of the gas bottles or cylinders which does not provide sufficient benefits for the actual user(s). Besides, this device is an additional unit, if directly attached to the high pressurized gas container, may have some safety risks and each pressurized gas container shall be equipped with a dual durable mechanical pressure gauge together with a pressure regulation mechanical valve that ensures the gas released from the pressurized container would not risk the applications. Attachment of the gas regulation valve before or after the disclosed device shall add an excessive part which makes the operational inconvenient while the disclosed device shall also require an external power source which adds other operational difficulties. This is in particular undesired for the vast number of residential applications.

### SUMMARY OF THE INVENTION

It is, therefore, the objective of the present disclosure to provide the design of an apparatus and the corresponding system that will allow both the end-users and consumer as well as the suppliers of the fuel gas cylinders to be instantly informed of the fuel consumption and cylinder status from such a device and system. Additionally, any potential leakage or safety status will also be registered and alarmed to the user as well as the supplier. Consequently, the management of the usage of fuel gas cylinders can be both safe and efficient. It will then be critical that the fuel consumption data can be measured directly and accurately without additional information or excessive calculation required, and further, the cost of the current management scheme will be reasonable and marketable for the significantly gained benefits. In the case of applications for residential fuel cylinders, the device and the system will also not require any additional parts to the end-users but a direct replacement of the current pure mechanical apparatus without losing but enhancing any advantageous features of the system, in particular of the safety features. The device will be stand-alone with the ability to be wirelessly interacting with the smart devices such as smart phones that are at reach by the users at any time that the smart devices can be further communicating with the destined cloud data that can be relayed to the fuel gas cylinder suppliers for inventory and manufacture management.

In one preferred embodiment, the disclosed apparatus will be integrated into the existing LPG (liquefied petroleum gas) fuel cylinder regulator into a single standalone unit. The primary usage is preferably to be for the fuel cylinders as fuel gas is one of the most used fuels in cylinder format. A simple mechanical device that is used to reduce the pressure from the cylinder to a couple of kilopascal above ambient is a mandatory apparatus for the usage of fuel gas in cylinders to power any appliances. This mechanical device is the only plug-in apparatus for use of fuel gas cylinders as the energy resources for appliances such as cooking wares for many of the residential households in the developing countries. Considering the actual application environments, it is not desirable to have the device as an additional or standalone apparatus even for the performance and safety enhancement as the vast number of users may not have the necessary knowledge for any additional connection and maintenance. This apparatus will then be desired to have the identical mechanical connections as those for the existing fuel gas cylinder pressure regulator. The addition to the existing pressure regulator will then be preferably placed at the gas outlet between the regulator body and the mechanical connector.

In one preferred embodiment, the smart addition that is integrated to the existing pressure regulator will have a MEMS mass flow sensing unit for metering the fuel gas consumption and a communication module to relay the information to the user as well as the supplier via the cloud data process.

The MEMS mass flow sensor chip in the MEMS mass flow sensing unit is fabricated by a micromachining technology similar to silicon CMOS technology. The micromachining technology is combining the technologies of thin film deposition, photolithography, and etching process to fabricate micro-devices in a micron or sub-micron scale. The MEMS mass flow sensor chip in the current invention is operated under calorimetric thermal mass flow sensing principle.

The MEMS mass flow sensing unit will be powered by a battery as a stand-alone unit and therefore it will be the same for the end-users in their use case. The MEMS mass flow sensing unit will directly and continuously measure the totalized fuel gas mass-consumed without the necessity for additional temperature and pressure measurement and averaging the plurality of the flow rates being registered once the end appliances are in use. The MEMS mass flow sensing unit will further have the memory in the form of an electronic flash that shall register the total consumed mass of the fuel gas in usage that can be pre-set by the supplier or the end-user. An alert will be sent to the user if the pre-set values were reached. The total fuel gas mass-consumed will be further added up by the values at each session and such information can be timely relayed to the user or the supplier. When the fuel gas is not in use, the MEMS mass flow sensing unit will go into a sleep mode to conserve the battery power.

In another preferred embodiment, the smart addition that is integrated to the existing pressure regulator will have a MEMS mass flow sensing unit for metering the fuel gas consumption and a communication module to relay the information to the user as well as the supplier via the cloud data process. The MEMS mass flow sensing unit as the added fuel gas consumption metering device will be placed at the exit of the pressure regulator. The exit will be made with a house of the MEMS mass flow sensing unit before the final connector to the external appliances. In such an arrangement, the device and the pressure regulator will be a single unit and there will be no changes in the actual usage by the end-user as for its operation and connection to the current fuel cylinders. The entire flow channel and the corresponding sensing electronics will be embedded inside the additional mechanical house to the pressure regulator that will be compatible and be in compliance with safety requirements for the existing fuel gas cylinders. The enclosure for the integrated MEMS mass flow sensing unit is preferred to be made completely with metals having the desired inlet and outlet identical to the existing pressure regulators. The metal base of the mass flow meter can also be made alternatively in a variety of formalities as long as the inlet/outlet gas consumption ports will be compatible with the current mechanical gas regulator models.

In another preferred embodiment, the smart addition that is integrated to the existing pressure regulator will have a MEMS mass flow sensing unit for metering the fuel gas consumption and a communication module to relay the information to the user as well as the supplier via the cloud data process. The MEMS mass flow sensing unit will have its flow channels for measurement of the fuel gas consumption in an assembly that will be composed of a plurality number of concentric cylinders that are evenly distributed in a cylinder formality serving as the metrology unit. As such the MEMS flow sensor chip will be placed at the center of the inner cylinder that will have the highest sensitivity. The number of the concentric cylinders can be scaled with the required flow channel size to host the maximal of the flowrate. This configuration will allow the flexibility of the MEMS mass flow sensing unit configuration that will be matched to the variety of the gas regulator and corresponding gas bottles or cylinders for the different applications or purposes. Thereafter, the full scale of the MEMS mass flow sensing unit can be adjusted via the changes of the sensor assembly that will be very cost-effective and easy for inventory management per the vast varieties of the fuel gas cylinder sizes.

In another preferred embodiment, the disclosed apparatus will have the MEMS mass flow sensing unit for metrology of the fuel gas consumption and relay the information to the user as well as the supplier via the cloud data process. The assembled and integrated fuel cylinder MEMS mass flow sensing unit and the pressure regulator apparatus will have the functionality of continuously metering the consumed fuel gas and relaying such information to the user via the connectivity to a smart device and further to the cloud for the assistance of the management to the fuel cylinder manufacturer. The new fuel cylinder apparatus will be readily connected to any fuel gas cylinders or containers by matching the integrated regulator with the desired fuel gas cylinders. In a preferred circumstance, the new fuel gas apparatus will also be utilized in other applications where fuel gas cylinders/containers are replaced by a fixed gas source or gas generator whilst the gas consumption information is also crucial to the users or the applications. In such a case, the MEMS mass flow sensing unit may be decoupled with the pressure regulator and directly connected to the supply flow channel or gas pipeline.

In yet another preferred embodiment, the disclosed apparatus will have the MEMS mass flow meter for metrology of the fuel gas consumption and relay the information to the user as well as the supplier via the cloud data process. The MEMS mass flow sensing unit shall further have the low energy version of Bluetooth or NB-IoT (narrowband Internet of Things) or other wireless communication components embedded inside the MEMS mass flow sensing unit. With this preferred configuration, the gas consumption data acquired by the MEMS mass flow sensing unit can be readily transmitted to smart devices such as a smart phone or a tablet that is widely available or accessible for the users. The software designated to be run on smart devices or the APP shall be used for further data logger and/or analysis for the interactive information of the fuel gas consumption status inside the fuel gas cylinder. The APP on a smart device will also be able to send the cylinder location to the cloud. In case that the smart device is not in proximity, a GPS module can be combined with the NB-IoT module to directly deliver the cylinder location to the designated data center or cloud. Meanwhile, the data registered in the MEMS mass flow sensing unit can also be downloaded to the smart devices via a wired data port such as USB data ports in case the wireless communication fails. Either the APP or the data connection via the wired data port will allow the user to program the MEMS mass flow sensing unit such that additional functions (e.g. fuel gas consumption low limit) can be customized. In an additional preferred embodiment, the measured data can be directly transmitted to a designated Cloud that hosts the database for desired fuel gas cylinders. The Cloud can also download the instructions to the designated MEMS mass flow sensing unit. The fuel gas cylinder manufacturer will then be able to manage the fuel cylinder schedule and inventory via the data from the Cloud. This will significantly help cylinder suppliers for service enhancement and efficiency.

The present disclosure provides a new design of an apparatus with an integrated flow meter and pressure regulator for fuel gas cylinders. This apparatus will be capable of continuously and precisely metering the fuel gas consumption while relaying such data to the user and further to the other interest parties such as fuel gas cylinder suppliers via a Cloud data infrastructure. These and other objectives of the present disclosure will become readily apparent upon further review of the following drawings and specifications. And additionally, for those with the knowledge of the art, the apparatus could be further utilized for gas delivery metering or dispensing via fixed gas sources or a gas generator.

### BRIEF DESCRIPTIONS OF THE DRAWINGS

FIG. 1 is the explosive view of the apparatus with an integrated MEMS mass flow sensing unit and gas pressure regulating which serves as a digitally connected device that is capable of timely communicating the status of the fuel gas cylinder to users as well as the fuel cylinder suppliers or the third party of interest.

FIG. 2A is the front view of the full assembled apparatus in this disclosure.

FIG. 2B is the back view of the full assembled apparatus in this disclosure.

FIG. 3 is the structural view of the flow sensing assembly where the MEMS sensor carrier printed circuit board PCB is placed at the center of the concentric cylinder channel.

FIG. 4A is the cross-section view of the scalable concentric flow channel cylinders, showing one size of the channels with numbers of the concentric cylinders.

FIG. 4B is the cross-section view of the scalable concentric flow channel cylinders, showing different size of the channels with different numbers of the concentric cylinders.

FIG. 5 is an example of the fully assembled apparatus on a gas cylinder that will not alter the current convention of usage.

FIG. 6 is a schematic showing the component interactions in the fuel gas cylinder management system with cloud data processing.

### DETAILED DESCRIPTION OF THE PREFERRED EMBODIMENTS

In the current energy delivery via fuel gas cylinders, a pressure regulator is a mandatory apparatus to reduce the highly pressurized fuel gas inside the cylinder such that the home appliances can be supplied. However, as of today, several options for gas consumption metering available on market are a standalone unit without the metrology precise. It is troublesome for the users for the requirements of installation as well as the imprecision of the acquired data. The deployment of these types of apparatus is therefore not feasible. In particular, for the applications in residential energy supply, the users have an extremely wide spectrum of the capability of handling the devices. The desired device needs to be as simple as possible and it is desired to be compatible with the existing pressure regulators. Also, it will be desired to add additional safety features for the benefits of the applications. It will be further beneficiary to have the gas consumption information made available to both the user and the supplier for the improvement of inventory, storage, delivery logistics as well as fuel gas cylinder manufacturer. Therefore, the disclosure will address these and all the related demands for the fuel gas cylinders.

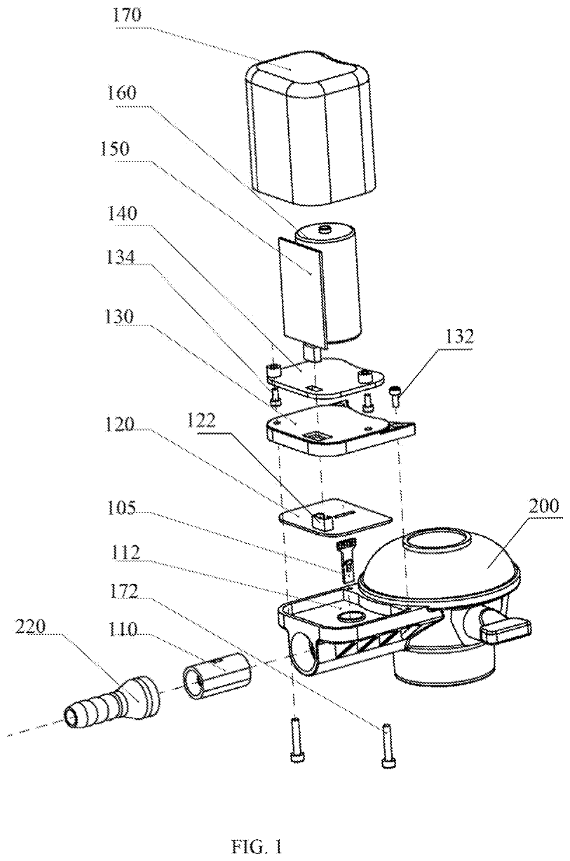

For the preferred embodiment, the present disclosure of an integrated mass flow meter with a pressure regulator for the fuel gas cylinders having the capability of remote data will have a MEMS mass flow sensing unit to measure the instant fuel gas consumption such that the fuel gas cylinder status can be continuously and precisely metered and the data will be relayed to both users via smart devices and fuel cylinder suppliers via remote data process (Cloud data). The explosive view of the integrated apparatus is shown in FIG. 1, where each component of the apparatus is disclosed. For the integrated apparatus, the pressure regulator 200 will be kept mostly intact except adding a MEMS mass flow sensor chip housing compartment 112. This house compartment will be preferred to be made via a metal casting process together with the pressure regulator house such that it will become a single unit. The flow channel 110 is preferred to be made by plastic injection using engineering plastics such as fiber-reinforced plastics. The preformed flow channel will have an internal flow conditioner and flow profiler that will allow the stable gas flow and ensure measurement accuracy and repeatability. It also will significantly reduce the metal machining cost and make the exchangeability possible. After the molded flow channel is engaged into the MEMS mass flow sensor chip housing compartment 112, the MEMS mass flow sensor carrier printed circuit board 105 can then be inserted into the flow channel via the opening in the housing compartment. The gas flow channel mechanical connector 220 to the gas fuel appliances will be normally a barbed nozzle and is preferred to be identical to those on the existing pressure regulators for compatibility. 120 is a printed circuitry board serving as the central control unit of the MEMS mass flow sensing unit, which contains the microcontroller unit (MCU) and signal conditioning circuitry for the MEMS flow sensor chip using components such as analog to digital converter (ADC), amplifiers and other necessary electronics components. It also contains an interface 122 to the power module and data transmission module. Besides, at least two physical memory chips such as e-flash are also parts of this unit with direct access by the MCU for data storage and data security. A physical data port in the form of a micro-USB or mini-USB or USB-C is also included for access to the data onboard in case the wireless data access is being disabled or not readily accessible. This physical data port is preferred not to be made available to the users but services only for data safety and interference risks. 132 is the cover of the central control unit to provide the necessary protection of the electronics from dust and liquid. This cover is fixed onto the meter housing compartment 112 with screws 132. Another pair of screws 134 are used to fix the printed circuitry board for power module 140 that is used to control the battery and provides the power interface to be connected to the central control electronics 120. This circuitry will also have the function of monitoring the battery power status and will trigger the power failure warning after that the remaining battery power is lower than 20%. This power level will be also programmable for specific applications and can be made with consequential warnings. 150 is a wireless module that provides data communication. The wireless module will be exchangeable depending on the local requirement or network availability. In a preferred embodiment, the module will contain both a low energy Bluetooth (BTLE) module and a longer distance wireless data module which can be NB-IoT, LoRa, WIFI, Sigfox, or other options. The BILE module is used for communicating the fuel gas cylinder status with the smart devices of nearby users while the other wireless module of choice will be used to communicate with the remote data center or the designated Cloud server. The battery 160 provides the power for the MEMS mass flow sensing unit and is preferred to be a lithium-ion battery with a high capacity of at least 9 Ah, as shown in the FIG. 1, for usage of over two years. Alternatively, the power can be supplied as well by two alkaline batteries which are easier to be acquired but will need to be changed more frequently depending on the actual usage. These above components are then enclosed with the flow meter cover 170 that is fixed to the MEMS mass flow sensor chip housing compartment 112 via a pair of screws 172. The cover is preferred to be made of aluminum alloy for the sturdy protection of the entire apparatus and be consistent with the materials of the pressure regulators. But alternatively, it can also be made with sturdy engineering plastics with impact absorbents. In order to have better resistance to rush environmental conditions, additional gaskets can be applied between the cover and the housing compartment.

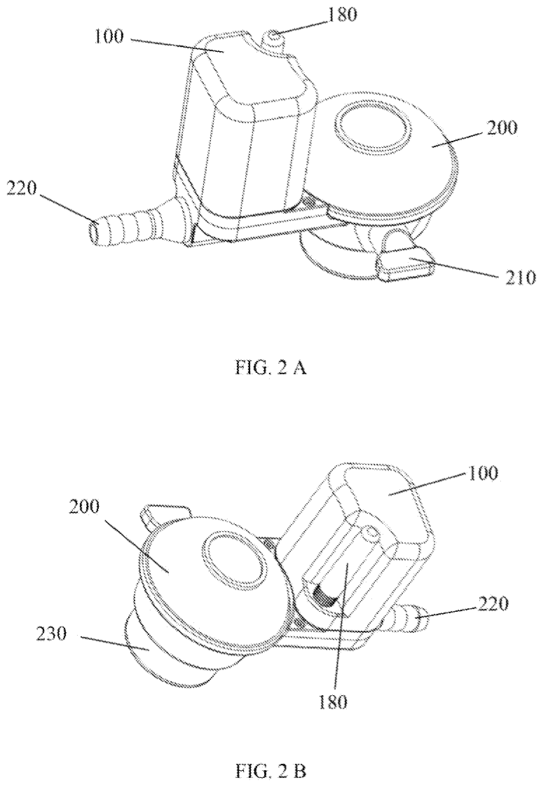

FIG. 2A and FIG. 2B exhibit the front and back view of the assembled MEMS mass flow sensing unit (100) with the pressure regulator (200) as a new smart apparatus for fuel gas cylinders. The antenna 180 is antenna for the wireless data module that can also be enclosed inside the meter cover (170) if the cover materials of sensing unit allow smooth data transmission. The knob 210 is used to adjust the pressure output, and 230 is a mechanical plug-in interface to the fuel gas cylinder. In the preferred embodiment, the apparatus will be operated by battery power, and it will continuously and precisely measure the instant mass flow rate of the fuel gas through the MEMS mass flow sensing unit while totalizing instantly the fuel gas being consumed. The measured data will be stored safely and separately in a plurality of physical memory chips for ultimate data safety. The data will be relayed to the user via the Bluetooth wireless communication to a smart device with programmed schedules or whenever the pre-set alarm is triggered. In one preferred embodiment, these data received by the smart devices will be further uploaded seamlessly to the designated Cloud or data center via the smart device network for the cloud data process which will be made accessible to the fuel gas cylinder suppliers. In another embodiment, in case the user's small device does not have network access, or the user does not possess an enabled smart device, the other long-distance wireless module will be activated and the collected data will be streaming to the data center or the designated Cloud. Once any alerts are received by the data center, the same information will be instantly relayed to the users with a registered communication tool such as a phone number or an email account. Any measurement can be programmed such as total fuel gas consumption limit, maximum or minimal gas flow rates, and/or time of gas consumption. In a preferred embodiment, the parameters that can be programmed via a user's smart devices will be limited for the database maintenance at the data center, or an additional layer of the programming/configuration will be provided.

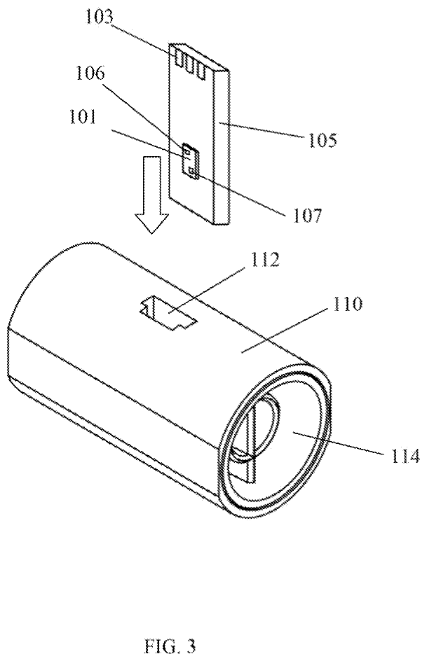

For the preferred embodiments, the flow measurement module will have a molded and scalable flow channel where the MEMS mass flow sensor chip will be inserted inside the center of the flow channel. This module can then be installed directly to the molded metal compartment without additional process or machining. FIG. 3 shows the schematic exhibition of these two parts of the flow measurement module. The MEMS mass flow sensor chip 101 is placed at the bottom center on the carrier printed circuitry board (PCB) 105. A pressure sensor 106 and a temperature sensor 107 are integrated in the same MEMS mass flow sensor chip. And the signal output interface 103 is the upper portion of the carrier PCB. The MEMS mass flow sensor utilizes the calorimetric or time-of-flight thermal mass flow sensing principle as disclosed previously by the present inventors. In the preferred embodiment, the sensing chip is preferred to be operated with the calorimetric mass flow sensing as no additional pressure and temperature sensing shall be required to directly meter the fuel gas mass consumption. An integrated thermal conductivity sensor on the same MEMS flow sensor chip can be used to identify the gas composition such that if an undesired gas component were present in the gas supply, the sensing unit shall also be able to send an alert to the users. Additional gauge pressure sensor element is also preferred to be integrated on the same flow sensor chip as for the majority of fuel gas supply to residential appliances, the regulated pressure must be in the required ranges otherwise the appliances will either not working properly or will lead to safety issues.

This additional monitoring of the pressure data combined with the flow rate monitor could also be used for the detection of any possible existence of fuel leakage that will not only a waste of the fuel but it will likely lead to a severe safety issue.

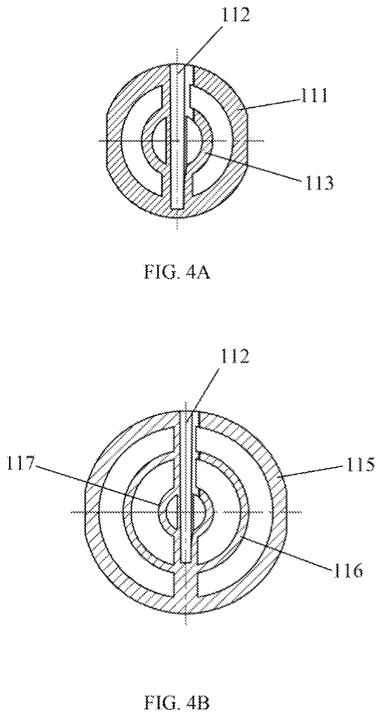

FIG. 4A and FIG. 4B exhibit the cross-section of the scalable flow channel configurations where the flow is partitioned by the concentric cylinders and the flow sensing and pressure sensing elements are placed at the center of the cylinders. This configuration provides a stable flow and ensures measurement accuracy. The partition of the flow channel is preferred for flow channel size larger than 5 mm in diameter. In the preferred embodiment, for a flow channel size of 8 mm, two concentric cylinders will be needed (FIG. 4A) and for a flow channel size of 12 mm, 3 concentric cylinders will be required (FIG. 4B). When there are more than 2 concentric cylinders, the space between any two cylinders is preferred to be identical. The outer cylinder (111, 115) is preferably to have a thicker wall while the inner cylinders (113, 116, and 117) are preferred to have thinner walls. The thickness of the inner cylinder walls is preferred to be within 1 mm. The sensing element carrier PCB will be installed inside the housing compartment 112 where the sensing elements will be located at the center of the cylinders.

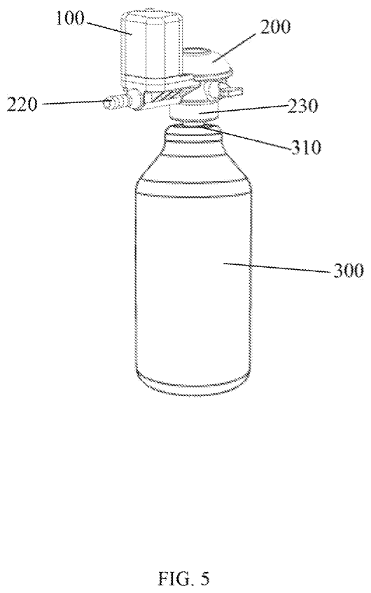

The advantages of the preferred embodiment are exhibited in FIG. 5 that is a typical installation of the apparatus on a fuel gas cylinder. In the preferred embodiment, the disclosed apparatus is connected to the fuel gas cylinder 300 via the standard connector 310 on the cylinder that will be engaged tightly with the connector on the apparatus 230. And the fuel cylinder connector 220 is also identical to those of the existing mechanical pressure regulators. This installation procedure will be exactly the same as that with a pure pressure regulator gauge. Therefore there is no requirement of training or whatsoever for the usage of the apparatus compared to those of the convention pressure regulator. Installation of the battery will be performed at the shipment of the regulator, and it is preferred not to be done by the users to prevent malicious tampering. As the apparatus will sending the power usage warning triggers to the user as well as to the designated data center or the Cloud, timely service will be normally guaranteed. In the worst case that the battery loses its power abruptly, it will not affect the usage of the fuel gas as there is no power-associated cut-off valve installed. However, the loss of communication will promptly trigger the service alarm which will lead to prompt attention to the failure recovery.

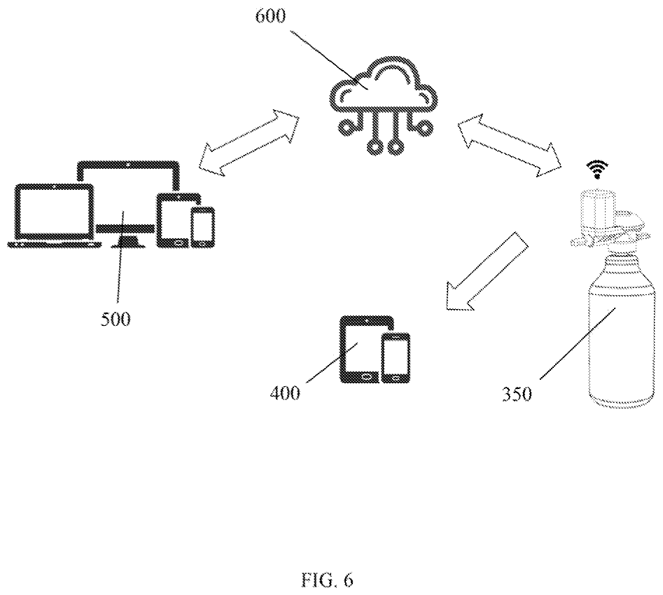

For the preferred embodiment, the interactions among the apparatus installed onto a fuel gas cylinder, the user with the smart devices, the Cloud with data process, and the third party such as fuel gas cylinder suppliers or service providers are exhibited in FIG. 6. The apparatus engaged with the cylinder 350 can be a single unit or a plurality of units and each of the units will have a unique digital address with a preferred communication module or protocol for the specific local requirements. Each of the apparatus will then communicate via Bluetooth to the smart device 400 with streaming of the gas consumption data as well as other fuel gas cylinder status data such as leakage and alarms. In one preferred embodiment, the apparatus can also be communicating with a nearby WIFI or a LoRa or other wireless protocol(s) for alerting the fuel gas cylinder users and relaying the data to the designated data center to the Cloud 600 for data process. The communication with the apparatus can also be a direct cloud data transmission module such as an NB-IoT module which is a dual-module configuration combining the local data relay. This module combined with the cylinder IDs will also provide the cylinder location data to the cloud, or alternative, a GPS module can be added to the module for additional location identification. The interactions between the apparatus and the local user or a smart device are preferable to be uni-directional to prevent the user tampering or unintentional interference with the apparatus. Additionally, a web-enabled passcode or a security password can allow the smart device to access the apparatus which will be preferable to provide to the cylinder suppliers or the third-party service providers. The interactions between the apparatus and the Cloud data center is preferably a bidirectional one where the apparatus will also be able to accept any alternative settings from the remote Cloud, in addition to uploading the fuel gas consumption as the fuel gas cylinder status. The interactions between the Cloud and the fuel gas cylinder suppliers or service providers 500 will also be preferable to be a bidirectional one that will allow the suppliers or service providers to upload the information to the Cloud that can be streaming to the designated fuel gas cylinders. Finally, users, suppliers, and third-party service providers will also be able to interact with the apparatus via both the Cloud and an APP on a smart device for various executable actions as disclosed in the previous embodiments.

For the additional preferred embodiments, the apparatus for those in the art shall become readily and apparently could be further incorporated with additional features such as an electrical driving valve for remote operation, and apply the disclosures to similar applications such as industrial gas cylinder usage. It shall also be readily and apparently that the apparatus shall also be equipped with other wireless communication tools such as a Sigfox or any data communications to interact with a local router or station for a large scale of clusters of the fuel gas cylinder management.

1. An integrated digital mass flow sensing and pressure regulating apparatus for fuel gas cylinders comprising:
A mechanical pressure regulator;
A molded scalable flow channel that re-partitions a gas flow via a plurality of concentric cylinders: wherein an diameter of the molded scalable flow channel is originally 6 mm with one concentric cylinder, wherein the diameter of the flow channel becomes 8 mm by adding one concentric cylinder, and the diameter of the flow channel becomes 12 mm by adding two concentric cylinders;
A microfabricated Micro-Electro-Mechanical System (MEMS) mass flow sensing unit with a MEMS mass flow sensor chip installed inside a housing compartment of the mechanical pressure regulator: wherein the MEMS flow sensor chip is operating with the a calorimetric thermal mass flow sensing principle, and working with a central control unit to measure an fuel gas mass flowrates, wherein the MEMS mass flow sensor chip is placed at center of the concentric cylinders inside the molded scalable flow channel;
An integrated low energy Bluetooth device that relays the fuel gas consumption data, a fuel gas cylinder status, and a fuel gas cylinder location to a smart device or to a designated data center;
An integrated long-range communication device that relays the fuel gas consumption data, the fuel gas cylinder status., and the fuel gas cylinder location to the designated data center;
A physical data port which is used to download the fuel gas consumption data and the cylinder status data , wherein the physical data port is embedded inside the apparatus and only can be accessed by fuel gas cylinder suppliers or third-party service providers; and
A battery compartment which allows the high capacity lithium-ion battery or a plural number of alkaline batteries.

2. The integrated digital mass flow sensing and pressure regulating apparatus for fuel gas cylinders of claim 1 wherein the mechanical pressure regulator are those regularly used for fuel gas cylinders on market, wherein pressure regulation structure and enclosure of the mechanical pressure regulator are not altered.

3. The integrated digital mass flow sensing and pressure regulating apparatus for fuel gas cylinders of claim 1 wherein the MEMS mass flow sensing unit is able to be independently calibrated, wherein the molded scalable flow channel made with concentric cylinders is connected to an exit of the mechanical pressure regulator and deliver the fuel gas to appliances using a gas delivery barbed port, wherein outer wall of the concentric cylinder will have a thickness ranged from 1.5 mm to 3 mm, and inner wall of the concentric cylinder has a thickness ranged from 0.8 to 1.5 mm, wherein the molded scalable flow channel and the concentric cylinders are made of engineering plastics or aluminum alloy to be consistent with build of the mechanical pressure regulator, and to meet safety requirements of corresponding industrial standards.

4. (canceled)

5. The integrated digital mass flow sensing and pressure regulating apparatus for fuel gas cylinders of claim 1 wherein the MEMS mass flow sensor chip is integrated with a pressure sensor and a temperature sensor on the MEMS mass flow sensor chip wherein the pressure sensor will gauge delivered fuel gas pressure from the mechanical pressure regulator and the temperature sensor will alert any abnormal operation temperature, wherein a pressure measurement data combined with a mass flow rates measurement data can be used to evaluate if there is a fuel gas leakage in order to timely alert users as well as the fuel gas, cylinder suppliers for safety purpose.

6. The integrated digital mass flow sensing and pressure regulating apparatus for fuel gas cylinders of claim 1 wherein the central control unit will has a capability to process an acquired mass flow rate data into a digital format and further totalize consumed fuel gas mass in each usage session, wherein the central control unit can process the acquired instant mass flow rate data in a way instructed by the fuel gas cylinder suppliers or the third-party service providers via preset parameters, wherein the central control unit can further drive the apparatus to communicate with a smart device at proximity or allow the acquired data to be downloaded or uploaded, wherein the central control unit further has a plurality of numbers of memory chips or devices that allow the acquired data can be simultaneously stored for data security purpose, and it also has other necessary functions such like password-protected access.

7. The integrated digital mass flow sensing and pressure regulating apparatus for fuel gas cylinders of claim 1 wherein the integrated low energy Bluetooth device will have a low energy Bluetooth communication enabled as well as antenna being placed outside or inside the MEMS mass flow sensing unit, but it is preferred to be placed inside for safety and prevention of tampering, wherein the low energy Bluetooth communication relays the gas consumption data as well as the fuel gas cylinder status to a smart device that is paired, wherein the smart device will run an APP that further relays the acquired data from the apparatus to a designated data center or a cloud for data processing, wherein in case that there are no smart devices at proximity area, another long-distance wireless data transfer modules selected from protocols of NB-IoT, WIFI, LoRa or Sigfox can be integrated inside the apparatus, and one of them will relay the acquired data and cylinder status to the designated data center or the cloud for data processing, wherein in most cases, one of the above long-distance wireless data transfer modules together with the cylinder ID can provide cylinder geographical location data, wherein for additional security of the geographical location data, a GPS module can be combined into any one of those long-distance wireless data transfer modules.

8. The integrated digital mass flow sensing and pressure regulating apparatus for fuel gas cylinders of claim 1 wherein the physical data port is used to manually download the fuel gas consumption data and the fuel gas cylinder status using a laptop computer or a smart phone, wherein the digital data devices can enable a wireless data transmission to a the designated data center, wherein the physical data port can be micro-USB, mini-USB or USB-C for easy accessibility.

9. (canceled)

10. The integrated digital mass flow sensing and pressure regulating apparatus for fuel gas cylinders of claim 1 wherein the MEMS mass flow sensing unit can work at a low power mode and is powered by a high-capacity lithium-ion battery or a pack of plural number of alkaline batteries on market, wherein for case of using lithium-ion battery a C-cell allows the apparatus to continuously work for two years, for case of using alkaline batteries, a pack of minimal of 4 AA battery will allow continuous operation for one year.
